(19) United States
(12) Patent Application Publication
(10) Pub. No.: US 2024/0045975 A1
(43) Pub. Date: Feb. 8, 2024

(54) PROCESSOR AND MULTI-CORE PROCESSOR

(71) Applicant: ALIBABA (CHINA) CO., LTD., ZHEJIANG PROVINCE (CN)

(72) Inventors: SHUANGCHEN LI, SUNNYVALE, CA (US); ZHE ZHANG, SHANGHAI (CN); LINYONG HUANG, HANGZHOU (CN); DIMIN NIU, SAN MATEO, CA (US); XUANLE REN, SHANGHAI (CN); HONGZHONG ZHENG, LOS GATOS, CA (US)

(21) Appl. No.: 18/066,207

(22) Filed: Dec. 14, 2022

(30) Foreign Application Priority Data
Aug. 3, 2022 (CN) 202210926062.X

(51) Int. Cl. G06F 21/60; G06F 21/54

(52) U.S. Cl. CPC G06F 21/602; G06F 21/54

(57) ABSTRACT

The present disclosure discloses a processor and a multi-core processor. The processor includes a processor core and a memory. The processor core includes a homomorphic encryption instruction execution module and a general-purpose instruction execution module; the homomorphic encryption instruction execution module is configured to perform homomorphic encryption operation and includes a plurality of instruction set architecture extension components, wherein the plurality of instruction set architecture extension components are respectively configured to perform a sub-operation related to the homomorphic encryption; the general-purpose instruction execution module is configured to perform non-homomorphic encryption operation. The memory is vertically stacked with the processor core and is used as a cache or scratchpad memory of the processor core.

### CROSS-REFERENCE TO RELATED APPLICATIONS

This application claims priority to PRC Patent Application No. 202210926062.X filed Aug. 3, 2022, which is incorporated herein by reference for all purposes.

### TECHNICAL FIELD

The present application relates to the technology in the field of information security, and particularly to a processor for use in performing function operation on ciphertext data and plaintext data.

### BACKGROUND

With the continuous development of new types of internet networks, data is growing explosively, and huge amount of data is often stored in cloud servers in the mode of entrusted computing services. Some data stored in the cloud often contain private information, or the data security mechanism in the cloud is not perfect, and some data information may be leaked easily. Thus, privacy data should be encrypted for protection purpose; however, once the data is encrypted, the original data structure of the original data is destroyed, and therefore, it is no longer feasible to process the information. For this reason, there is a need for a cryptographic technique that can encrypt the data and ensure that the encrypted data can be processed. The fully homomorphic encryption algorithm not only protects the privacy of the original data, but also supports arbitrary homomorphic addition and homomorphic multiplication of ciphertext data, providing a general security solution for cloud computing and big data environments.

However, homomorphic encryption requires complex operations, and the operation process requires a lot of data exchange with the cache and/or memory. Therefore, how to achieve these requirements with a low cost has become one of the most important issues to be addressed in the related field.

### SUMMARY

One embodiment of the present disclosure is directed to a processor, characterized in that the processor includes a processor core and a memory. The processor core includes: a homomorphic encryption instruction execution module, configured to perform a homomorphic encryption operation, wherein the homomorphic encryption instruction execution module includes a plurality of instruction set architecture extension components, and the plurality of instruction set architecture extension components are respectively configured to perform a sub-operation related to the homomorphic encryption; and a general-purpose instruction execution module, configured to perform non-homomorphic encryption operation. The memory is vertically stacked with the processor core and is used as the cache or scratchpad of the processor core.

Another embodiment of the present disclosure is directed to a multi-core processor, which includes a plurality of fore-going processors.

The processor and processor core of the present disclosure can be used in performing homomorphic encryption operation and non-homomorphic encryption operation. Since the memory is arranged outside of the processor core, and the processor core and the memory are vertically stacked in a three-dimensional space, and the memory is used as the cache or scratchpad memory of the processor core, it can be arranged to have a larger storage, and the bandwidth between the processor core and the memory is also greatly increased.

### BRIEF DESCRIPTION OF THE DRAWINGS

Aspects of the present disclosure are best understood from the following detailed description when read with the accompanying figures. It should be noted that, in accordance with the standard practice in the field, various structures are not drawn to scale. In fact, the dimensions of the various structures may be arbitrarily increased or reduced for the clarity of discussion.

FIG. 1 is a sectional view of a three-dimensional integrated circuit package according to embodiments of the present application.

FIG. 2 is a functional block diagram of a processor core according to a first embodiment of the present application.

FIG. 3 is a functional block diagram of a processor core according to a second embodiment of the present application.

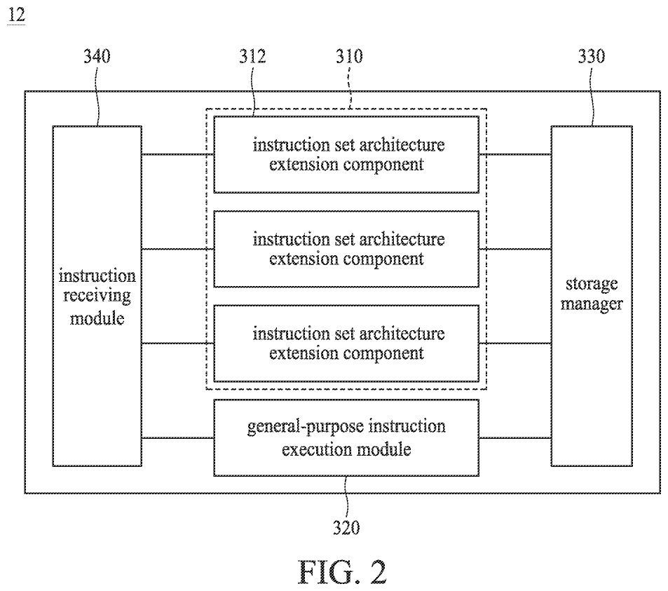

For example, FIG. 4 is a functional block diagram of a first embodiment of the homomorphic encryption instruction execution module of FIG. 2 implemented using a reconfigurable architecture.

For example, FIG. 5 is a functional block diagram of a second embodiment of the homomorphic encryption instruction execution module of FIG. 2 implemented using a reconfigurable architecture.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in various examples. This repetition is for the purpose of simplicity and clarity and does not in itself dictate a relationship between the various embodiments and/or configurations discussed.

Moreover, spatially relative terms, such as “beneath,” “below,” “lower,” “above,” “upper”, “on” and the like, may be used herein for ease of description to describe one element or feature's relationship to another element(s) or feature(s) as illustrated in the figures. These spatially relative terms are intended to encompass different orientations of the device in use or operation in addition to the orientation depicted in the drawings. The apparatus may be otherwise oriented (rotated 90 degrees or at other orientations) and the spatially relative descriptors used herein may likewise be interpreted accordingly.

As used herein, the terms such as “first”, “second” and “third” describe various elements, components, regions, layers and/or sections, these elements, components, regions, layers and/or sections should not be limited by these terms. These terms may be only used to distinguish one element, component, region, layer or section from another. For example, the terms such as “first”, “second” and “third” when used herein do not imply a sequence or order unless clearly indicated by the context.

As used herein, the singular forms “a,” “an” and “the” are intended to include the plural forms as well, unless the context clearly indicates otherwise. The term “connect,” and its derivatives, may be used herein to describe the structural relationship between components. The term “connected to” may be used to describe two or more components in direct physical or electrical contact with each other. The term “connected to” may also be used to indicate that two or more components are in direct or indirect (with intervening components therebetween) physical or electrical contact with each other, and/or that the two or more components collaborate or interact with each other.

Generally, if a general processor is used to process instructions related to homomorphic cryptographic operations, the operations become extremely complex and lengthy. Therefore, many accelerator solutions for homomorphic cryptography have been proposed in the related art. However, over-optimization of the hardware tends to lose the flexibility of the processor and makes the processor incompatible with most of the specification requirements. Therefore, the present disclosure provides a solution that not only takes into account the performance of the processor in performing both homomorphic and non-homomorphic cryptographic operations, but also easily keeps the processor compatible with various usage scenarios with different specifications when performing homomorphic cryptographic operations; the details are discussed below.

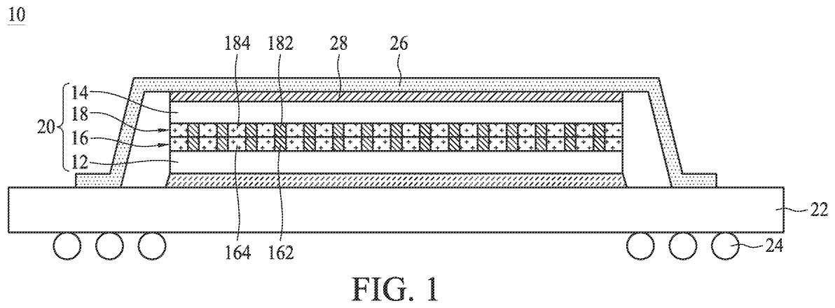

Since homomorphic cryptographic operations require a larger amount of data accessing than non-homomorphic cryptographic operations, in order to avoid the storage space and bandwidth from becoming performance bottlenecks, the present disclosure arranges the memory outside the processor core to increase the storage space and stacks the memory on top of the processor core in the form of a three-dimensional integrated circuit to obtain a high bandwidth. FIG. 1 is a sectional view of a three-dimensional integrated circuit package 10 according to embodiments of the present application. The three-dimensional integrated circuit package 10 includes a processor core 12 and a memory 14. The processor core 12 and the memory 14 are coupled together to form a processor 20 via a connection structure 16 and a connection structure 18. In the present embodiment, the connection structure 16 and the connection structure 18 may be coupled to each other in a hybrid bonding manner, but the present application is not limited to this. In the present embodiment, the processor core 12 and the memory 14 are both bare chips, more specifically, the processor core 12 and the connection structure 16 form a first bare chip; the memory 14 and the connection structure 18 form a second bare chip. Compared to the arrangements of two-dimensional integrated circuit or 2.5-dimensional integrated circuit, the processor core 12 and memory 14 are stacked vertically in a three-dimensional space, which can reduce the complexity of wirings, so that more signals can exist in the interface between the processor core 12 and the memory 14, thereby further reducing the length of connection line so as to decrease the RC delay. In the present embodiment, the processor 20 formed by the processor core 12 and the memory 14 has Turing completeness, which means that the processor 20 can be programmed, so that the processor 20 can do all the things that can be done with a Turing machine to solve all computable problems. In other words, the processor 20 can act as a general-purpose computer. In some embodiments, the processor is a CPU, such as a RISC-V processor; the memory 14 may be a dynamic random access memory. Details regarding the processor core 12 will be discussed below.

In FIG. 1, the memory 14 is arranged on top of the processor core 12; and the metal pad 162 at the upper surface of the processor core 12 is bonded to the metal pad 182 at the lower surface of the memory 14 in a hybrid bonding manner. A dielectric layer 164 at the upper surface of the processor core 12 surrounds the metal pad 162; a dielectric layer 184 at the lower surface of the memory 14 surrounds the metal pad 182.

The three-dimensional integrated circuit package 10 can be further coupled to a substrate 22, a solder ball 24 and a heat sink cover 26. The substrate 22 can be a semiconductor substrate (e.g., a silicon substrate), an intermediate layer or a printed circuit board, etc.; discrete passive devices such as resistors, capacitors, transformers, etc. (not shown) may also be coupled to the substrate 22. The solder ball 24 is attached to the substrate 22, wherein the processor 20 and the solder balls 24 are located on opposite sides of the substrate 22. The heat sink cover 26 is mounted on the substrate 22 and wraps around the processor 20. The heat sink cover 26 may be formed using a metal, metal alloy, etc., such as a metal selected from the group consisting of aluminum, copper, nickel, cobalt, etc.; the heat sink cover 26 may also be formed from a composite material selected from the group consisting of silicon carbide, aluminum nitride, graphite, etc. In some embodiments, an adhesive 28 may be provided on top of the processor 20 for adhering the heat sink cover 26 to the processor 20 to improve the stability of the three-dimensional integrated circuit package 10. In some embodiments, the adhesive 28 may have a good thermal conductivity so as to accelerate the dissipation of heat energy generated during operation of the processor 20. In some embodiments, the memory 14 may be arranged below the processor core 12 such that the memory 14 is located between the processor core 12 and the substrate 22.

The processor 20 can be applied in a server in a cloud environment (hereinafter, a cloud server) for processing data in different formats. More specifically, the processor core 12 in the processor 20 can perform functional computation on ciphertext data and plaintext data, according to on a user's request, where the ciphertext data has a first format and the plaintext data has a second format; the memory 14 is used as a cache and/or scratchpad memory of the processor core 12 for storing intermediate or final computation results obtained during the functional computation. In certain embodiments, the user may encrypt the data to be computed by homomorphic encryption algorithms to obtain ciphertext data and send the instructions (containing the function to be computed), ciphertext data and plaintext data to the cloud server; after the processor 20 located in the cloud server computes the ciphertext data and the plaintext data separately, it then returns the computation results to the user. In some embodiments, the user can upload and store (for a long term) the plaintext data and the ciphertext data obtained by homomorphic encryption algorithm in the cloud server; the processor 20 can compute the plaintext data and the ciphertext data stored in the cloud server according to the instructions sent by the user, and then send the computation results to the user or store them in the cloud server.

FIG. 2 is a functional block diagram illustrating a first embodiment of the processor core 12 of FIG. 1. The processor core 12 includes at least a homomorphic encryption instruction execution module 310 and a general-purpose instruction execution module 320. The homomorphic encryption instruction execution module 310 is configured to perform homomorphic encryption operation, meaning that it can perform computation operation on the ciphertext data without decryption, such as addition and multiplication of ciphertexts. The general-purpose instruction execution module 320 is used to perform non-homomorphic encryption operations, meaning that it can perform certain general-purpose instructions, such as performing computation operation on plaintext data.

An instruction receiving module 340 of the processor core 12 is coupled to the homomorphic encryption perform module 310 and the general-purpose instruction execution module 320, and is used to receive instructions and correspondingly control the homomorphic encryption perform module 310 and the general-purpose instruction execution module 320 to perform corresponding operations according to the type of the received instruction. Generally, the instructions received by the processor 20 include homomorphic encryption instructions related to ciphertext data process and non-homomorphic encryption instructions related to plaintext data process. When the instruction receiving module 340 receives the homomorphic encryption instruction, it will assign the homomorphic encryption instruction to the homomorphic encryption perform module 310; when the instruction receiving module 340 receives the non-homomorphic encryption instruction, it will assign the non-homomorphic encryption instruction to the general-purpose instruction execution module 320.

The homomorphic encryption instruction execution module 310 can include a plurality of instruction set architecture extension components 312, each instruction set architecture extension component 312 is configured to perform sub-operations related to homomorphic encryption. In certain embodiments, the sub-operation performed by the instruction set architecture extension components 312 can include performing number theoretic transform (NTT) operation, KeySwitch operation, modulus operation or data manipulation operation etc. on ciphertext data; in other words, each instruction set architecture extension component 312 only has the capability to perform a specific sub-operation. In the present embodiment, before the instruction receiving module 340 transfers the homomorphic encryption instruction to the homomorphic encryption instruction execution module 310, it will first break down the homomorphic encryption instruction into a plurality of sub-operations, and then assigns a plurality of sub-operations to a least a portion of the instruction set architecture extension components 312 of the homomorphic encryption perform module 310 according to the property of a plurality of sub-operations and the purpose and number of a plurality of instruction set architecture extension components 312. In the present embodiment, the type and complexity of the computation functions to be processed and the desired speed and hardware cost can be used to determine which functional instruction set architecture extensions 312 are to be included and how many instruction set architecture extensions 312 are to be configured for each function. The number (3) of instruction set architecture extension components 312 shown in FIG. 2 is for illustrative purposes only. For example, the homomorphic encryption instruction execution module 310 may include two instruction set architecture extension components 312 for performing number-theoretic transform operations, one instruction set architecture extension component 312 for performing KeySwitch operations, and four instruction set architecture extension components 312 for performing modulo operations and data manipulation operations. In some embodiments, more instruction set architecture extension components 312 can be provided to increase the performance of the homomorphic encryption instruction execution module 310; however, in some embodiments, the number of instruction set architecture extension components 312 can be reduced to save the hardware cost of the homomorphic encryption instruction execution module 310. In either case, the instruction receiving module may arrange them based on the type and number of instruction set architecture extension components 312 in the homomorphic encryption instruction execution module 310.

The processor core 12 can further include a storage manager 330, coupled between the homomorphic encryption instruction execution module 310 and the memory 14 of FIG. 1; and the storage manager 330 is further coupled between the general-purpose instruction execution module 320 and the memory 14 of FIG. 1. The storage manager 330 is configured to manage the storage of ciphertext data and plaintext data in the memory 14. Specifically, when the processor 20 performs homomorphic encryption operation, the instruction set architecture extension components 312 responds to each sub-operation of the computation function and the intermediate or final computation results obtained by performing computation on the ciphertext data has a first format, and the storage manager 330 is used to access the data having the first format in the memory 14. When the processor 20 performs non-encryption computation, the general-purpose instruction execution module 320 responds to the computation function and the intermediate or final computation results obtained by performing computation on the plaintext data has a second format, which has a more regular and shorter length, compared to that of the first format, and the storage manager 330 is configured to access the data having the second format in the memory 14. Since the processor 20 according to the present application is form from the vertically stacked processor core 12 and memory 14, so that the memory 14 has a larger storage and higher band width; this eliminates the need for a cache or scratchpad memory in the processor core 12 to save cost. However, the present application is not limited thereto; in certain embodiments, a small amount of cache and/or scratchpad memory may also be provided in the processor core 12 as needed.

In certain embodiments, a plurality of the foregoing processors 20 may be arranged and coupled in a two-dimensional mesh network to form a multi-core processor, such as a thousand-core processor. A plurality of processors 20 in the multi-core processor may be configured to perform different functional computing, and the plurality of processors 20 are connected in series with each other to perform parallel computing. In some embodiments, a plurality of processor cores 12 of a plurality of processors 20 may be located on a bare chip at the same time; a plurality of memories 14 of a plurality of processors 20 may be located on another bare chip at the same time.

A plurality of processors 20 of the multi-core processor can be configured to perform different functional computations, a plurality of processors 20 are serially connected with each other to perform parallel computations. In certain embodiments, a plurality of processor cores 12 of a plurality of processors 20 may be located on a bare chip at the same time; a plurality of memories 14 of a plurality of processors 20 may be located on another bare chip at the same time.

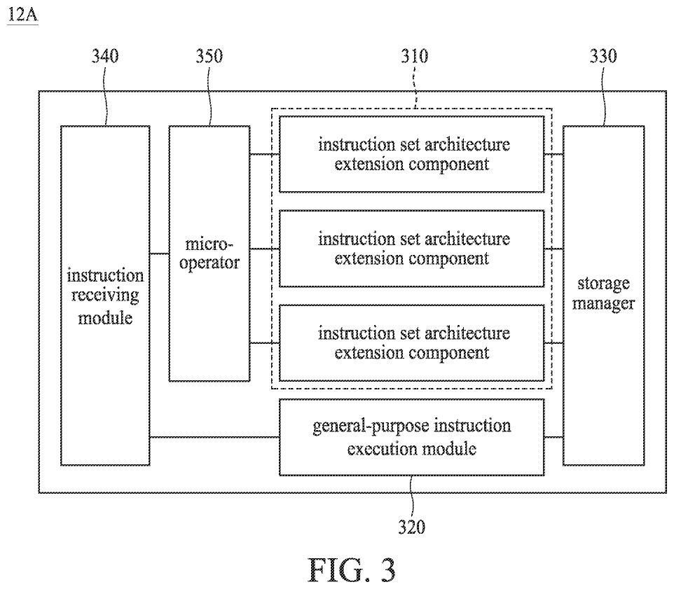

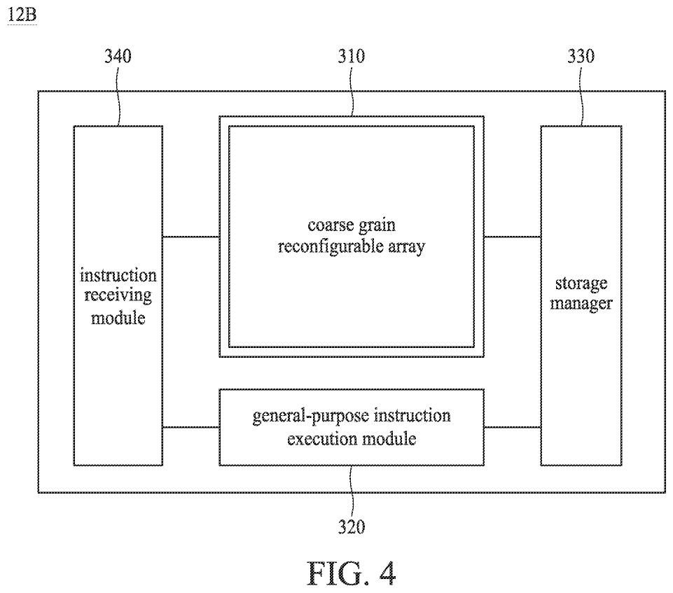

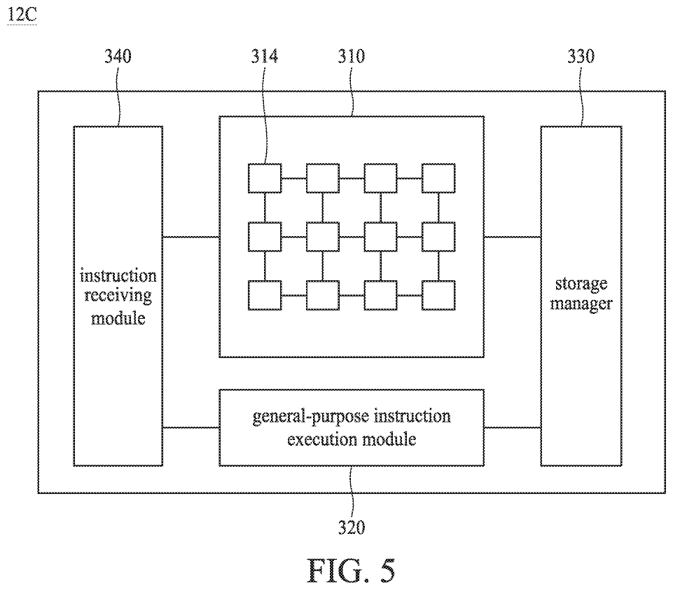

FIG. 3 is a functional block diagram illustrating a first embodiment of the processor core of FIG. 1. The processor core 12A includes a homomorphic encryption instruction execution module 310, a general-purpose instruction execution module 320, a storage manager 330, an instruction receiving module 340 and a micro-operator 350. The processor core 12 and the processor core 12A have similar structures, and can operate according to similar principles. The processor core 12A differs from the processor core 12 in that the micro-operator 350 coupled between the instruction receiving module 340 and the homomorphic encryption perform module 310 is configured to share a portion of the work task performed by the instruction receiving module 340, so as to reduce the workload of the instruction receiving module 340.

Specifically, in the processor core 12A, the instruction receiving module 340 is responsible for receiving instruction, identifying whether the received instruction is a homomorphic encryption instruction or a non-homomorphic encryption instruction, and assigning the homomorphic encryption instruction to the micro-operator 350 and assigning the non-homomorphic encryption instruction to the general-purpose instruction execution module 320. The micro-operator 350 will assign a plurality of sub-operation of the homomorphic encryption instruction to a specific or non-specific instruction set architecture extension components 312 according to the capability (e.g., performing one or more of the number theoretic transform operation, KeySwitch operation, modulus operation or data manipulation operation) and workload of the instruction set architecture extension components 312.

As mentioned above, the type and complexity of the computation functions to be processed and the desired speed and hardware cost can be used to determine which functional instruction set architecture extensions 312 are to be included and how many instruction set architecture extensions 312 are to be configured for each function. That is, the setting of the plurality of instruction set architecture extension components 312 in the homomorphic encryption instruction execution module 310 often needs to be adjusted according to the application of the product in which the processor 20 is located. Therefore, in some embodiments, a reconfigurable architecture can be implemented for the homomorphic encryption instruction execution module 310 to save the time and money required to redevelop the chip.

For example, FIG. 4 is a functional block diagram of a first embodiment of the homomorphic encryption instruction execution module 310 of FIG. 2 implemented using a reconfigurable architecture. The processor core 12 and the processor core 12B have similar structures, and can operate according to similar principles. The processor core 12B differs from the processor core 12 in that the homomorphic encryption perform module 310 of the processor core 12B is implemented using a coarse grain reconfigurable array. The coarse grain reconfigurable array is an architecture consisting of a matrix of lattice-like interconnected blocks that together implement homomorphic encryption operations. The coarse grained reconfigurable array is configured to implement a plurality of instruction set architecture extension components 312 used to perform sub-operation related to homomorphic encryption in the processor core 12. It should be noted that the coarse grained reconfigurable array may also be used to implement the homomorphic encryption instruction execution module 310 of the embodiment of FIG. 3.

FIG. 5 is a functional block diagram of a second embodiment of the homomorphic encryption instruction execution module 310 of FIG. 2 implemented using a reconfigurable architecture. The processor core 12 and the processor core 12C have similar structures, and can operate according to similar principles. The processor core 12C differs from the processor core 12 in that the homomorphic encryption instruction execution module 310 is implemented using a programmable processing unit array 314. The programmable processing unit array 314 can be arranged in a two-dimensional mesh network and connected via a network-on-chip (NoC). The programmable processing unit array 314 can be configured to implement a plurality of instruction set architecture extension components 312 used to perform sub-operation related to the homomorphic encryption in the processor core 12. It should be noted that the programmable processing unit array units may also be used to implement the homomorphic encryption instruction execution module 310 of the embodiment of FIG. 3.

The processor 20 and/or multi-core processor proposed in the present application is capable of handling the complex operations required for homomorphic encryption in an efficient and cost-effective manner through the three-dimensional structure of the processor core 12 and memory 14, together with a flexible design in the homomorphic encryption instruction execution module 310.

The foregoing outlines features of several embodiments of the present application so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A processor, comprising:
a processor core, comprising:
a homomorphic encryption instruction execution module, configured to perform homomorphic encryption operation, wherein the homomorphic encryption instruction execution module comprises a plurality of instruction set architecture extension components, the plurality of instruction set architecture extension components, respectively configured to perform a sub-operation related to homomorphic encryption; and
a general-purpose instruction execution module, configured to perform non-homomorphic encryption operation; and
a memory, vertically stacked with the processor core and for use as a cache or scratchpad memory of the processor core.

2. The processor of claim 1, wherein when the processor performs the homomorphic encryption operation, the data delivered between the processor core and the memory has a first format; when the processor performs the non-homomorphic encryption operation, the data delivered between the processor core and the memory has a second format, and the processor further comprises a storage manager, configured to manage the storage of the data in the first format and the data in the second format in the memory.

3. The processor of claim 1, wherein the processor core further comprises a instruction receiving module, configured to receive a homomorphic encryption instruction, and correspondingly arrange the plurality of instruction set architecture extension components of the homomorphic encryption instruction execution module according to the homomorphic encryption instruction, to perform the homomorphic encryption instruction.

4. The processor of claim 3, wherein the instruction receiving module is further configured to receive a non-homomorphic encryption instruction, and control the general-purpose instruction execution module to perform the non-homomorphic encryption instruction.

5. The processor of claim 3, wherein the instruction receiving module further comprising a micro-operator, coupled to the plurality of instruction set architecture extension components, and is configured to decode the homomorphic encryption instruction and arrange the plurality of instruction set architecture extension components of the homomorphic encryption instruction execution module accordingly.

6. The processor of claim 1, wherein a sub-operation of the plurality of instruction set architecture extension components includes a instruction set architecture extension component configured to perform number theoretic transform operation.

7. The processor of claim 1, wherein the plurality of instruction set architecture extension components comprise a instruction set architecture extension component configured to perform KeySwitch operation.

8. The processor of claim 1, wherein the plurality of instruction set architecture extension components comprise a instruction set architecture extension component configured to perform modulus operation.

9. The processor of claim 1, wherein the plurality of instruction set architecture extension components comprise an instruction set architecture extension component configured to perform data manipulation operation.

10. The processor of claim 1, wherein the homomorphic encryption instruction execution module is implemented using a coarse grain reconfigurable array.

11. The processor of claim 1, wherein the homomorphic encryption instruction execution module is implemented using a programmable processing unit array.

12. The processor of claim 1, wherein the memory is a dynamic random access memory.

13. The processor of claim 1, wherein the memory is connected to the processor core in a hybrid bonding manner.

14. The processor of claim 1, wherein the processor is a RISC-V processor.

15. A multi-core processor, comprising:
a plurality of processors of claim 1.

16. The multi-core processor of claim 15, wherein the plurality of processors are arranged in a two-dimensional mesh network.
